(19) United States
(12) Patent Application Publication
(10) Pub. No.: US 2026/0038720 A1
(43) Pub. Date: Feb. 5, 2026

(54) COOLING SYSTEM, MAGNETIC FIELD GENERATOR, AND METHOD OF OPERATION

(71) Applicant: TERAL INC., Fukuyama-shi, Hiroshima (JP)

(72) Inventors: Hiroshi KAWASHIMA, Fukuyama-shi, Hiroshima (JP); Tetsuya ITO, Fukuyama-shi, Hiroshima (JP)

(73) Assignee: TERAL INC., Fukuyama-shi, Hiroshima (JP)

(21) Appl. No.: 18/996,176

(22) PCT Filed: Sep. 26, 2023
(86) PCT No.: PCT/JP2023/035003

§ 371 Date: Jan. 17, 2025

(30) Foreign Application Priority Data
Oct. 19, 2022 (JP) 2022-167959

(51) Int. Cl. H01F 6/04; H01F 6/06

(52) U.S. Cl. CPC H01F 6/04; H01F 6/06

(57) ABSTRACT

A cooling system (RS) includes a vacuum insulation container (4), an object to be cooled (3), a cryogenic refrigerator (CR), a thermal conduction connector (TC), a temperature sensor (TS), current leads (D1, D2), and a controller. The temperature sensor detects the temperature of one of the object to be cooled, a cold stage, the thermal conduction connector, and the current leads. The controller performs an operation stop process to stop operation of the cryogenic refrigerator in a case in which, while the cryogenic refrigerator is operating, the temperature detected by the temperature sensors drops to a predetermined target cooling temperature, and an operation start process to start operation of the cryogenic refrigerator in a case in which, while operation of the cryogenic refrigerator is stopped, the temperature detected by the temperature sensor rises to a predetermined operation start temperature that is higher than the predetermined target cooling temperature.

### TECHNICAL FIELD

The present disclosure relates to a cooling system, a magnetic field generator, and a method of operation.

The present application claims priority to Japanese Patent Application No. 2022-167959 filed on Oct. 19, 2022, the entire contents of which are incorporated herein by reference.

### BACKGROUND

Conventionally, cryogenic refrigerators have been used for cooling an object to be cooled. For example, see PTL (Patent Literature) 1.

### CITATION LIST

### Patent Literature

PTL 1: JP H05-312425 A

### SUMMARY

### Technical Problem

A conventional cryogenic refrigerator is always operated at a nearly constant output. Hence, even after the temperature of the object to be cooled has dropped sufficiently, the cryogenic refrigerator continues to cool the object to be cooled at an equivalent output, which may lead to wasted driving energy.

To address the above-described issue, the present disclosure aims to provide a cooling system, a magnetic field generator, and a method of operation that can reduce the driving energy of a cryogenic refrigerator.

### Solution to Problem

[1]A cooling system comprising:
a vacuum insulation container;
an object to be cooled, arranged in the vacuum insulation container;
a cryogenic refrigerator comprising a cold stage configured to generate cold;
a thermal conduction connector connecting the cold stage and the object to be cooled in a thermally conductive manner;
one or more temperature sensors;
a current lead arranged in the vacuum insulation container; and
a controller, wherein
the one or more temperature sensors are each configured to detect a temperature of one of the object to be cooled, the cold stage, the thermal conduction connector, and the current lead, and
the controller is configured to perform
   an operation stop process to stop operation of the cryogenic refrigerator in a case in which, while the cryogenic refrigerator is operating, the temperature detected by any one of the one or more temperature sensors drops to a predetermined target cooling temperature, and
   an operation start process to start operation of the cryogenic refrigerator in a case in which, while operation of the cryogenic refrigerator is stopped, the temperature detected by any one of the one or more temperature sensors rises to a predetermined operation start temperature that is higher than the predetermined target cooling temperature.

[2] The cooling system according to [1], wherein the predetermined target cooling temperature is equal to or greater than a temperature of the cold stage when a cooling load of the cold stage is 5 W.

[3] The cooling system according to [1] or [2], wherein
the object to be cooled is configured to include a high-temperature superconducting wire, and
the predetermined operation start temperature is equal to or less than a maximum temperature at which the high-temperature superconducting wire can be made superconducting.

[4] The cooling system according to any one of [1] to [3], wherein the thermal conduction connector comprises a cold storage body.

[5] The cooling system according to [4], wherein the cold storage body has a greater heat capacity than the object to be cooled.

[6] The cooling system according to [4] or [5], wherein
the thermal conduction connector comprises one or more heat equalizing members, and
the one or more heat equalizing members are in contact with the cold storage body over an entire outer circumferential surface of the cold storage body.

[7] The cooling system according to [6], wherein
the thermal conduction connector comprises one or more cooling conduction members, and
the one or more cooling conduction members are in contact with the one or more heat equalizing members and the object to be cooled.

[8] The cooling system according to any one of [4] to [7], wherein
the cold storage body is a core member,
the object to be cooled is a superconducting coil, and
the superconducting coil is wound around the core member.

[9] The cooling system according to any one of [4] to [8], wherein
the cooling system is configured for use in a magnetic field generator,
the magnetic field generator comprises
   the cooling system, and
   a yoke that is substantially C-shaped or substantially U-shaped, wherein
the cooling system comprises one or a pair of the vacuum insulation containers,
the cooling system comprises a pair of superconducting coils, each superconducting coil being the object to be cooled,
the cooling system comprises a pair of split cores, each split core being the cold storage body,
the pair of split cores are configured separately from the yoke, are located inside the yoke, and are arranged facing each other with a working space therebetween,
in each split core, each superconducting coil is wound along a circumferential direction centering on an axis parallel to a direction in which the pair of split cores face each other,
a split core coil assembly comprising the split core and the superconducting coil wound around the split core is housed in the one or pair of the vacuum insulation containers, and
the yoke is arranged outside of the one or pair of vacuum insulation containers.

[10]A magnetic field generator comprising:
the cooling system according to any one of [4] to [8]; and
a yoke that is substantially C-shaped or substantially U-shaped, wherein
the cooling system comprises one or a pair of the vacuum insulation containers,
the cooling system comprises a pair of superconducting coils, each superconducting coil being the object to be cooled,
the cooling system comprises a pair of split cores, each split core being the cold storage body,
the pair of split cores are configured separately from the yoke, are located inside the yoke, and are arranged facing each other with a working space therebetween,
in each split core, each superconducting coil is wound along a circumferential direction centering on an axis parallel to a direction in which the pair of split cores face each other,
a split core coil assembly comprising the split core and the superconducting coil wound around the split core is housed in the one or pair of the vacuum insulation containers, and
the yoke is arranged outside of the one or pair of vacuum insulation containers.

[11]A method of operation for the cooling system according to any one of [1] to [8], the method comprising:
stopping, by the controller, operation of the cryogenic refrigerator in a case in which, while the cryogenic refrigerator is operating, the temperature detected by any one of the one or more temperature sensors drops to a predetermined target cooling temperature; and
starting, by the controller, operation of the cryogenic refrigerator in a case in which, while operation of the cryogenic refrigerator is stopped, the temperature detected by any one of the one or more temperature sensors rises to a predetermined operation start temperature that is higher than the predetermined target cooling temperature.

### Advantageous Effect

According to the present disclosure, a cooling system, a magnetic field generator, and a method of operation that can reduce the driving energy of a cryogenic refrigerator can be provided.

### BRIEF DESCRIPTION OF THE DRAWINGS

In the accompanying drawings:

FIG. 1 is a cross-sectional view schematically illustrating a magnetic field generator, according to an embodiment of the present disclosure, that includes a cooling system according to an embodiment of the present disclosure;

FIG. 2 is a cross-sectional view illustrating an enlargement of the cooling unit in FIG. 1;

FIG. 3 is a perspective view schematically illustrating the cooling unit in FIG. 2;

FIG. 4 is a perspective view schematically illustrating the portion of the cooling unit in FIG. 3 excluding the vacuum insulation container and the radiation shield;

FIG. 5 is an exploded perspective view illustrating the split core coil assembly of FIG. 3 in a disassembled state;

FIG. 6 is a cross-sectional diagram illustrating an enlargement of a portion of the magnetic field generator in FIG. 1;

FIG. 7 is a diagram illustrating an example of the capacity curve of a two-phase cryogenic refrigerator; and

FIG. 8 is a diagram illustrating an example of the critical current characteristics of a REBCO wire, which is a type of high-temperature superconducting wire.

### DETAILED DESCRIPTION

The cooling system and the method of operation according to the present disclosure can be used to cool any object to be cooled and can be suitably used, for example, to cool superconducting coils. The cooling system and the method of operation according to the present disclosure can also be used in any device and can be used, for example, in a magnetic field generator.

The magnetic field generator according to the present disclosure can be used for any application and can be used, for example, in an aluminum billet heating device.

Embodiments of the cooling system, magnetic field generator, and method of operation according to the present disclosure are illustrated below with reference to the drawings.

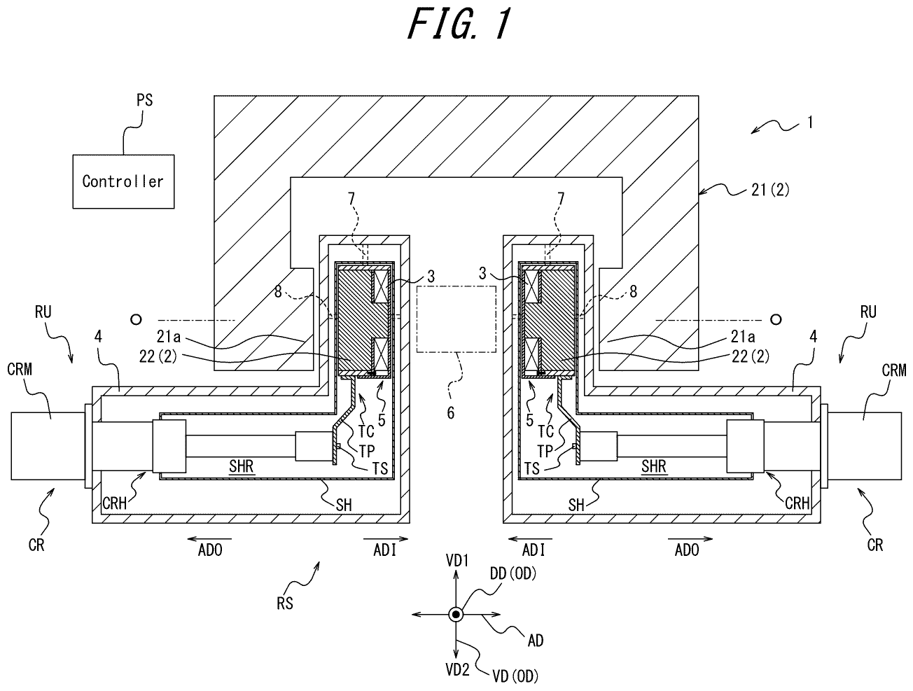

FIG. 1 illustrates a magnetic field generator 1, according to an embodiment of the present disclosure, that includes a cooling system RS according to an embodiment of the present disclosure. The cooling system RS of the present embodiment is configured for use in the magnetic field generator 1.

As illustrated in FIG. 1, the magnetic field generator 1 according to the present embodiment includes a cooling system RS according to an embodiment of the present disclosure and a yoke 21. The cooling system RS of the present embodiment includes a pair of cooling units RU and a controller PS. Each cooling unit RU includes a vacuum insulation container 4, an object to be cooled 3, a cryogenic refrigerator CR, a thermal conduction connector TC, a temperature sensor TS, and a radiation shield SH. The cooling system RS (and hence the magnetic field generator 1) of the present embodiment includes a pair of each of the vacuum insulation container 4, the object to be cooled 3, the cryogenic refrigerator CR, the thermal conduction connector TC, the temperature sensor TS, and the radiation shield SH. In the present embodiment, the thermal conduction connector TC has one or more (in the present embodiment, one) thermal conduction members TP, one or more (in the present embodiment, four) heat equalizing members SK, one or more (in the present embodiment, two) cooling conduction members PM, and a cold storage body 22. The cooling system RS (and hence the magnetic field generator 1) of the present embodiment includes a pair of the cold storage bodies 22.

Each cooling unit RU is configured to cool the respective object to be cooled 3.

Since the configuration of each cooling unit RU is similar in the present embodiment, it is assumed that when the cooling unit RU or its components are described below, the description is applicable to each of the cooling units RU unless otherwise noted.

In the present embodiment, the object to be cooled 3 is a superconducting coil 3. The object to be cooled 3 may be referred to below as the “superconducting coil 3”.

In the present embodiment, the cold storage body 22 is a core member 22 and is a split core 22. The cold storage body 22 may be referred to below as the “core member 22” or the “split core 22”.

The vacuum insulation container 4 is configured so that a vacuum is maintained therein. The vacuum insulation container 4 is thereby configured to maintain the cool temperature of the components inside the vacuum insulation container 4 cooled by the cryogenic refrigerator CR.

The object to be cooled 3, a portion of the cryogenic refrigerator CR, the thermal conduction connector TC, the temperature sensor TS, and the radiation shield SH are arranged inside the vacuum insulation container 4.

A core 2 is configured by the yoke 21 and a pair of split cores 22 (i.e., cold storage bodies 22 or core members 22).

The yoke 21 is configured to include iron and is configured to pass magnetic flux. The yoke 21 is substantially C-shaped or substantially U-shaped (substantially C-shaped in the example in FIG. 1). The yoke 21 has a pair of ends 21a. In the example in FIG. 1, the yoke 21 is oriented so that the pair of ends 21a face a working space 6. However, the ends 21a of the yoke 21 may be oriented in any direction as long as the yoke 21 is provided with a surface facing a surface on the axial direction outside ADO of the split core 22 with a narrow gap therebetween.

The yoke 21 is arranged outside of the pair of vacuum insulation containers 4.

The pair of split cores 22 are configured to include iron and are configured to pass magnetic flux. The pair of split cores 22 are configured separately from the yoke 21. The pair of split cores 22 are located inside the yoke 21 and are arranged facing each other with the working space 6 therebetween. The working space 6 is an air gap.

The core 2 is thus substantially C-shaped.

In the present specification, the direction parallel to the axis O extending through the pair of split cores 22 and in the direction in which the pair of split cores 22 face each other is referred to as the “axial direction AD”. The side closer to the working space 6 in the axial direction AD is referred to as “axial direction inside ADI”, and the side farther from the working space 6 in the axial direction AD is referred to as “axial direction outside ADO”. The direction perpendicular to the axial direction AD is referred to as the “axial orthogonal direction OD”. The side closer to the axis O in the axial orthogonal direction OD is referred to as the “axial orthogonal direction inside”, and the side farther from the axis O in the axial orthogonal direction OD is referred to as the “axial orthogonal direction outside”. In the present specification, the circumferential direction centered on the axis O is sometimes simply referred to as the “circumferential direction”. Unless otherwise specified, the “outer circumferential side” and “inner circumferential side” refer to the outer circumferential side and inner circumferential side, respectively, when the axis O is the center.

In the present specification, one direction perpendicular to the axial direction AD is referred to as the “longitudinal direction VD”, and the direction perpendicular to both the axial direction AD and the longitudinal direction VD is referred to as the “depth direction DD”. One side in the longitudinal direction VD is referred to as the “longitudinal direction first side VD1”, and the other side in the longitudinal direction VD is referred to as the “longitudinal direction second side VD2”.

In the present embodiment, the longitudinal direction VD is oriented vertically, and the longitudinal direction first side VD1 is oriented upward, but the longitudinal direction VD may be oriented in any direction.

The pair of split cores 22 and the pair of ends 21a of the yoke 21 face each other in the axial direction AD. The pair of split cores 22 are positioned toward the axial direction inside ADI relative to the pair of ends 21a of the yoke 21. The surfaces on the axial direction outside ADO of the pair of split cores 22 face the surfaces on the axial direction inside ADI of the pair of yokes 21 with a narrow gap therebetween.

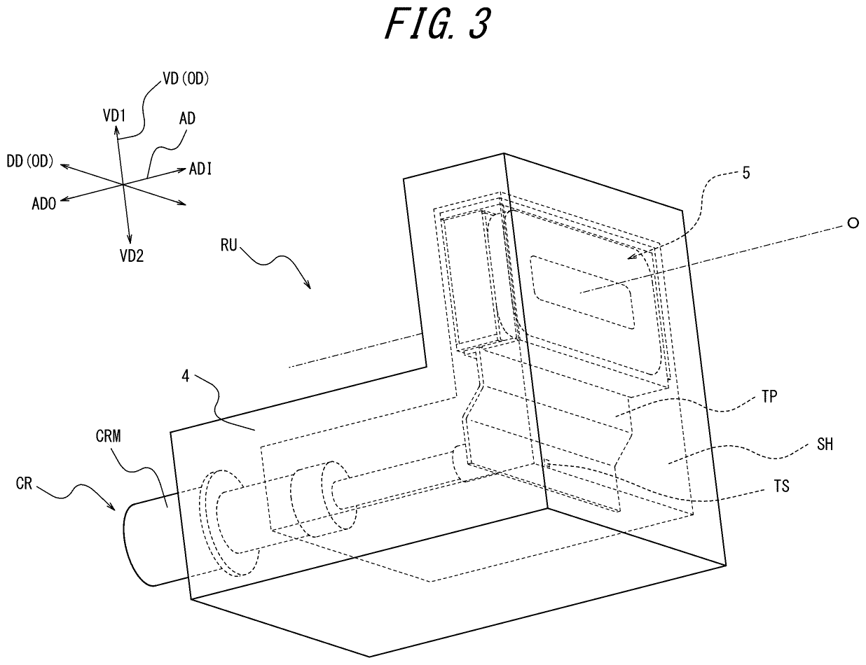

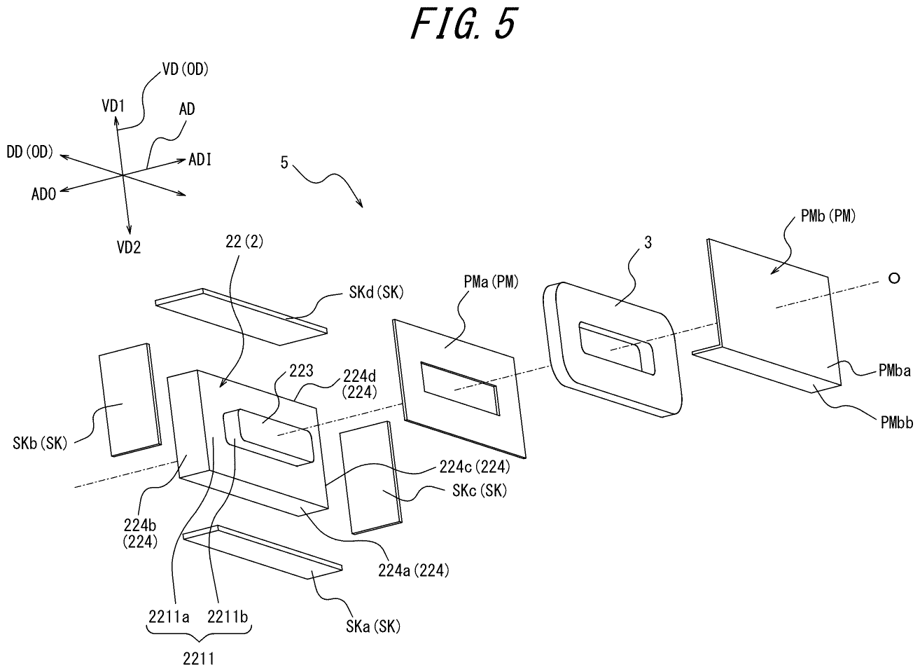

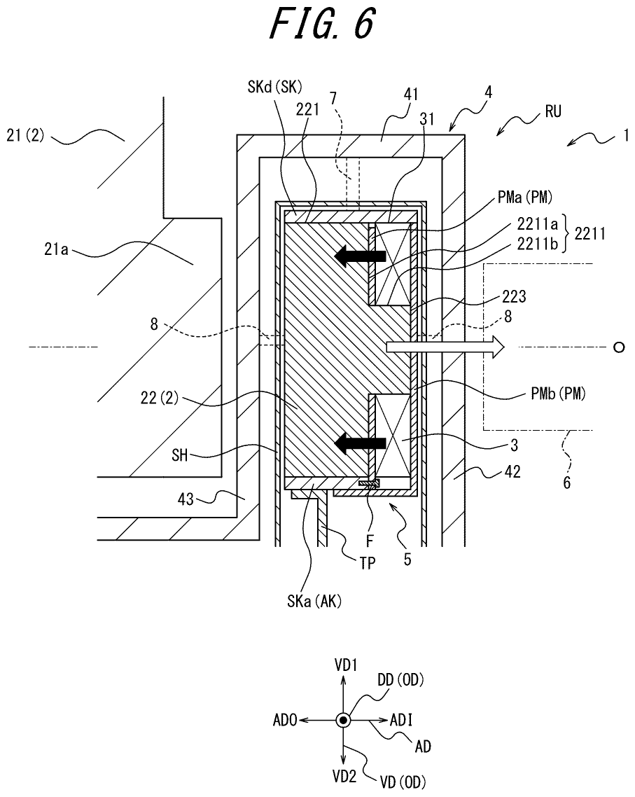

As illustrated in FIGS. 1 to 6, superconducting coils 3 are wound around the split cores 22. More specifically, the superconducting coils 3 are wound around the split cores 22 along the circumferential direction centered on the axis O (in other words, circumferentially around the axis O). The superconducting coil 3 is located at the outer circumferential side of an outer circumferential surface 221 of the split core 22 (specifically, a below-described axial direction face 2211b of a step 2211 on the outer circumferential surface 221, FIGS. 5 and 6) and is separated from and faces the outer circumferential surface 221 (specifically, the axial direction face 2211b) in the radial direction. However, the superconducting coil 3 may be in contact with the outer circumferential surface 221 (for example, the axial direction face 2211b) of the split core 22.

The superconducting coil 3 is configured to include a superconductor. In other words, the superconducting coil 3 is configured to include a coil body (superconducting wire) containing a superconductor. The coil body (superconducting wire) of the superconducting coil 3 is preferably a high-temperature superconducting wire. The coil body of the superconducting coil 3 is, for example, configured in the form of a strip. In addition to the coil body, the superconducting coil 3 may further include a coil case that houses the coil body inside. The coil case is, for example, made of resin or the like.

As illustrated in FIG. 5, in the present example, the superconducting coil 3 has a substantially square ring shape surrounding the axis O in a cross-section in the axial orthogonal direction OD. The superconducting coil 3 may, however, have any ring shape, such as a substantially circular ring shape or a substantially elliptical ring shape, as long as the ring shape surrounds the axis O in a cross-section in the axial orthogonal direction OD.

While omitted from the drawings, the magnetic field generator 1 includes a current supply unit to apply current, such as direct current (DC), to the superconducting coil 3.

The superconducting coil 3 is cooled by the cryogenic refrigerator CR until the superconducting wire, and hence the superconductor, configuring the superconducting coil 3 becomes superconducting (and hence until the electrical resistance becomes substantially zero).

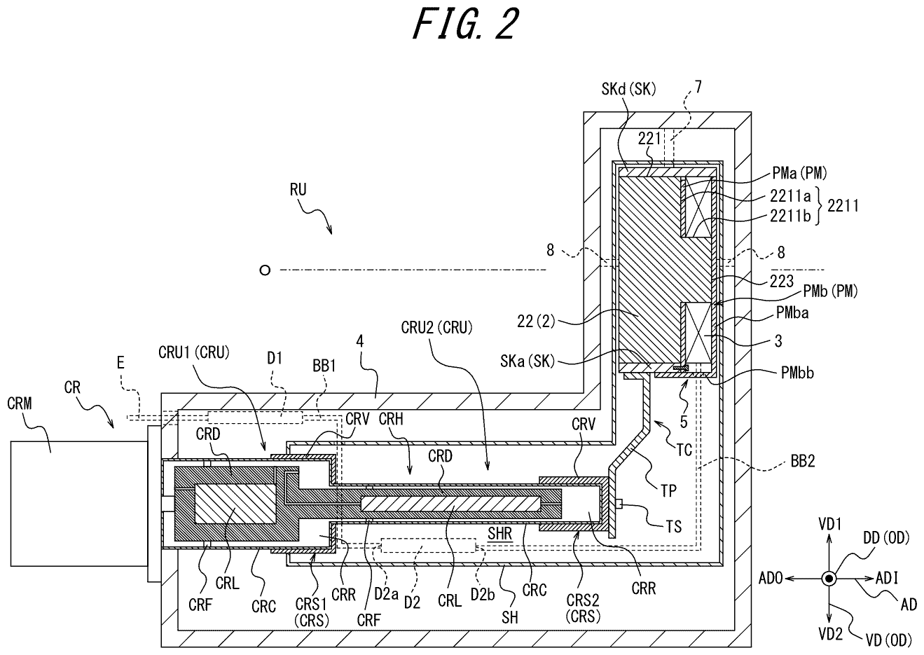

As illustrated in FIGS. 1 and 2, the split core 22 and the superconducting coil 3 wound around the split core 22 form a split core coil assembly 5. In other words, the split core coil assembly 5 has the split core 22 and the superconducting coil 3 wound around the split core 22. In the present embodiment, the cooling system RS (and hence the magnetic field generator 1) has a pair of split core coil assemblies 5.

In the present embodiment, the split core coil assembly 5 has one or more (in the present embodiment, four) heat equalizing members SK and one or more (in the present embodiment, two) cooling conduction members PM, in addition to the split core 22 and the superconducting coil 3.

Each split core coil assembly 5 is housed in a corresponding vacuum insulation container 4. The yoke 21 is arranged outside of the pair of vacuum insulation containers 4. The pair of vacuum insulation containers 4 face each other in the axial direction AD with the working space 6 therebetween.

As illustrated in FIG. 6, a wall 42 on the axial direction inside ADI in the vacuum insulation container 4 is located between the split core coil assembly 5 and the working space 6. A wall 43 on the axial direction outside ADO in the vacuum insulation container 4 is located between the split core coil assembly 5 and the end 21a of the yoke 21.

In the magnetic field generator 1 configured in this way, when a current is applied to the superconducting coil 3 by a non-illustrated current supply unit, magnetic flux passes through the core 2 (yoke 21 and a pair of split cores 22), and a strong magnetic field is generated in the working space 6.

The strong magnetic field generated in the working space 6 may be used for any purpose.

For example, the magnetic field generator 1 may be used in a heating device for aluminum billets. In this case, in addition to the magnetic field generator 1, the heating device includes a motor for rotating an aluminum billet. A DC current is applied to the superconducting coil 3, which in turn causes a DC strong magnetic field to be generated in the working space 6. The aluminum billet is arranged in the working space 6 with the central axis of the aluminum billet extending in the depth direction DD and is rotated around the central axis of the aluminum billet by the motor. This configuration is equivalent to having an alternating magnetic field applied to the aluminum billet, and an induced current flows in the aluminum billet, heating the aluminum billet.

The cryogenic refrigerator CR may have any conventionally known configuration. The cryogenic refrigerator CR is preferably a cold storage cryogenic refrigerator, more specifically, for example, a Gifford-McMahon (GM) refrigerator.

As illustrated in FIG. 2, the cryogenic refrigerator CR has one or more (in the present embodiment, two) cold stages CRS, which are configured to generate cold.

More specifically, in the present embodiment, the cryogenic refrigerator CR is configured as a two-stage GM refrigerator. As illustrated in FIG. 2, in the present embodiment, the cryogenic refrigerator CR has a cold head CRH and a motor CRM. In the present embodiment, the cold head CRH has two cold units CRUs (first phase cold unit CRU1 and second phase cold unit CRU2) each configured to generate cold. Each cold unit CRU includes a cylinder CRC, a displacer CRD configured to be reciprocally movable inside the cylinder CRC along the extending direction of the cylinder CRC, a cold storage material CRL arranged inside the displacer CRD, a sealing member CRF provided between the cylinder CRC and the displacer CRD, and a sleeve CRV. The “extending direction of the cylinder CRC” refers to a direction parallel to the central axis of the cylinder CRC. An expansion chamber CRR is partitioned between the cylinder CRC and the tip surface of the displacer CRD. The sleeve CRV is made of metal, and the sleeve CRV covers, from the outside, the portion of the cylinder CRC that partitions the expansion chamber CRR. However, the sleeve CRV need not be provided. The cold unit CRU has the cold stage CRS in the vicinity of the expansion chamber CRR. The cold stage CRS is configured to generate cold, and more specifically, is configured to reach a temperature equivalent to the temperature of the cold generated in the expansion chamber CRR. The cold stage CRS is, for example, formed by the sleeve CRV and a portion of the cylinder CRC that partitions the expansion chamber CRR. The two cold units CRU are connected in series. Specifically, the cylinders CRC of the cold units CRU and the displacers CRD of the cold units CRU are connected to each other in series. The second phase cold unit CRU2 is located at the tip of the cold head CRH relative to the first phase cold unit CRUL.

The motor CRM is, for example, configured to drive (move reciprocally) the displacer CRD housed in the cold head CRH.

A compressor (not illustrated) is connected to the cryogenic refrigerator CR. The compressor is connected to the cold head CRH and configured to compress refrigerant gas. The refrigerant gas is, for example, helium gas.

An inverter (not illustrated) may be connected to the cryogenic refrigerator CR. In this case, the inverter is, for example, connected between the power supply of the cryogenic refrigerator CR and the compressor and is configured to set the power supply frequency of the cryogenic refrigerator CR to a predetermined power supply frequency.

While the cryogenic refrigerator CR configured as described above is operating, the high-pressure refrigerant gas compressed by the compressor (not illustrated) passes through the cold storage material CRL and is cooled by the cold stored in the cold storage material CRL in each cold unit CRU. The refrigerant gas is then guided to the expansion chamber CRR and is further cooled by expanding adiabatically. The cooled refrigerant gas is then returned through the cold storage material CRL, and the cold of the refrigerant gas is left at that time in the cold storage material CRL. By repetition of this operation, the temperature of the expansion chamber CRR and hence the cold stage CRS is gradually lowered. During this operation, the temperature of the cold generated in the cold stage CRS becomes lower towards the cold unit CRU further downstream (at the tip). In other words, in the present embodiment, the temperature of cold generated in the cold stage CRS of the second phase cold unit CRU2 (hereinafter also referred to as the “second phase cold stage CRS2”) is lower than the temperature of cold generated in the cold stage CRS of the first phase cold unit CRU1 (hereinafter also referred to as the “first phase cold stage CRS1”).

The cryogenic refrigerator CR may be configured as a single-phase cryogenic refrigerator with only one cold unit CRU, or as a multi-phase cryogenic refrigerator with any number of cold stages CRS.

In the present embodiment, the cold head CRH of the cryogenic refrigerator CR is arranged inside the vacuum insulation container 4, and the parts of the cryogenic refrigerator CR other than the cold head CRH (motor CRM, power supply, and the like), along with the compressor (not illustrated), inverter, and the like are arranged outside the vacuum insulation container 4. This prevents excess heat from the parts of the cryogenic refrigerator CR other than the cold head CRH from entering the vacuum insulation container 4.

As illustrated in FIGS. 1 to 5, the thermal conduction connector TC connects the most downstream (most towards the tip) cold stage CRS (in the present embodiment, the second phase cold stage CRS2) in the cryogenic refrigerator CR with the object to be cooled 3 in a thermally conductive manner. As a result, the heat of the object to be cooled 3 is absorbed (and hence cooled), via the thermal conduction connector TC, by the most downstream cold stage CRS (in the present embodiment, the second phase cold stage CRS2) in the cryogenic refrigerator CR.

The thermal conduction connectors TC may each be configured by any one or more members each made of a metal or other thermal conductor.

In the present embodiment, the thermal conduction connector TC has one or more (in the present embodiment, one) thermal conduction members TP, one or more (in the present embodiment, four) heat equalizing members SK, one or more (in the present embodiment, two) cooling conduction members PM, and a cold storage body 22 (i.e., the split core 22 or core member 22), each of which is made of a metal or other thermal conductor.

As illustrated by the dashed lines in FIG. 2, a first current lead D1 and a second current lead D2, which are each current leads, are arranged in the vacuum insulation container 4 in the present embodiment.

One end of the first current lead D1 is connected to a first bus bar BB1. The first bus bar BB1 is in contact with the first phase cold stage CRS1. The other end of the first current lead D1 is connected to a hermetic feed-through terminal E. The hermetic feed-through terminal E is attached to a wall of the vacuum insulation container 4.

The second current lead D2 has a high-temperature end D2a on one side and a low-temperature end D2b on the other side. The high-temperature end D2a of the second current lead D2 is connected to the first bus bar BB1. The low-temperature end D2b of the second current lead D2 is connected to the second bus bar BB2. The second bus bar BB2 is connected to the superconducting coil 3. The low-temperature end D2b of the second current lead D2 is cooled by a terminal of the superconducting coil 3, which is cooled by the second phase cold stage CRS2. The high-temperature end D2a of the second current lead D2 is cooled by the first phase cold stage CRS1.

The temperature sensor TS is configured to detect the temperature of one of the object to be cooled 3, the cold stage CRS of the cryogenic refrigerator CR (preferably, the most downstream (most towards the tip) cold stage CRS (in the present embodiment, the second phase cold stage CRS2)), the thermal conduction connector TC, and the current leads D1, D2 (preferably, the second current lead D2). The temperature of the most downstream (most towards the tip) cold stage CRS (in the present embodiment, the second phase cold stage CRS2) in the cryogenic refrigerator CR is quickly transmitted to the object to be cooled 3 via the thermal conduction connector TC. The temperature of each of the object to be cooled 3, the cold stage CRS (in the present embodiment, the second phase cold stage CRS2), and the thermal conduction connector TC therefore tends to be nearly equivalent. The temperature sensor TS performs the aforementioned temperature detection periodically (at predetermined time intervals) or continuously. The temperature detection results by the temperature sensor TS are outputted to the controller PS by wired communication and/or wireless communication.

The temperature sensor TS is preferably arranged inside the vacuum insulation container 4 and is more preferably in contact with the component whose temperature is to be detected (object to be cooled 3, cold stage CRS, thermal conduction connector TC, or current leads D1, D2).

In the present embodiment, as illustrated in FIG. 1, the temperature sensor TS is in contact with, and is configured to measure the temperature of, the thermal conduction connector TC (more specifically, the thermal conduction member TP).

The controller PS is configured to include a processor, such as a CPU, for example, and is configured to perform the below-described method of operation by executing a program stored in a memory (not illustrated). Specifically, the controller PS is configured to perform various processes, described below, by executing the program, thereby controlling the cryogenic refrigerator CR based on the detection results by the temperature sensor TS. The controller PS may further be configured to control a compressor and/or an inverter connected to the cryogenic refrigerator CR.

The memory (not illustrated) is configured by ROM and/or RAM, for example, and stores various information, such as programs to be executed by the controller PS. The memory may be external to the controller PS or internal to the controller PS.

In the present embodiment, only one controller PS is provided for each pair of cooling units RU, as illustrated in FIG. 1. That is, one controller PS is used to perform the below-described method of operation in each cooling unit RU.

However, one controller PS may be provided for each cooling unit RU, i.e., respective controllers PS may perform the below-described method of operation in the corresponding cooling unit RU.

The method of operation according to an embodiment of the present disclosure is now described. This method of operation is a method of operation for a cooling system RS and can be used in any embodiment of the cooling system RS described in the present specification.

First, the power of the cryogenic refrigerator CR is turned on. The temperature sensor TS periodically (at predetermined time intervals) or continuously detects the temperature of one of the object to be cooled 3, the cold stage CRS of the cryogenic refrigerator CR (in the present embodiment, the second phase cold stage CRS2), the thermal conduction connector TC, and the current leads D1, D2, and outputs the detection result to the controller PS.

The controller PS performs an operation stop process to stop operation of the cryogenic refrigerator CR in a case in which, while the cryogenic refrigerator CR is operating, the temperature detected by the temperature sensor TS drops to a predetermined target cooling temperature THL (operation stop step).

The controller PS performs an operation start process to start operation of the cryogenic refrigerator CR in a case in which, while operation of the cryogenic refrigerator is stopped, the temperature detected by the temperature sensor TS rises to a predetermined operation start temperature THH that is higher than the predetermined target cooling temperature THL (operation start step).

In this method of operation, after the power supply of the cryogenic refrigerator CR is turned on, the operation stop process (operation stop step) and the operation start process (operation start step) are thus alternately repeated.

The controller PS may, for example, stop/start the operation of the cryogenic refrigerator CR by turning OFF/ON the power supply of the compressor and the cryogenic refrigerator CR. More specifically, the controller PS may turn OFF/ON the power supply of the compressor so that control to stop/start the operation of the cryogenic refrigerator CR is accordingly implemented automatically from the compressor, thereby stopping/starting the operation of the cryogenic refrigerator CR. Alternatively, in a case in which each of the compressor and the cryogenic refrigerator CR is configured to be controlled by a signal, the controller PS may output a control signal to the compressor and the cryogenic refrigerator CR to stop/start operation, thereby stopping/starting the operation of the cryogenic refrigerator CR.

While the cryogenic refrigerator CR is operating, the drive capacity of the cryogenic refrigerator CR (power supply frequency, input power to the compressor, and the like) is maintained at a constant level. From the perspective of improving the drive efficiency of the cryogenic refrigerator CR, the power supply frequency of the cryogenic refrigerator CR during operation is preferably set to 50 Hz or 60 Hz, more preferably 60 Hz. In general, in a commercial cryogenic refrigerator CR, the compressor and motor CRM connected to the cryogenic refrigerator CR are operated at a common power frequency of 50 Hz or 60 Hz. In general, the refrigeration efficiency is better when the power supply frequency is 60 Hz. The power supply input to the compressor and the motor CRM could be set to 50 Hz or 60 Hz with an inverter.

In addition to radiation and heat transfer from the walls of the vacuum insulation container 4, the components in the vacuum insulation container 4 can be subjected to intrusive heat from outside the vacuum insulation container 4 through the components (current leads D1, D2 and the like) that extend into the vacuum insulation container 4. While operation of the cryogenic refrigerator CR is stopped, the temperature of the object to be cooled 3 can rise due to such intrusive heat from the outside.

According to the method of operation of the present embodiment, the cryogenic refrigerator CR is not continuously operated, but rather once the temperature of the object to be cooled 3 drops sufficiently during operation, the operation is stopped, and when the temperature of the object to be cooled 3 becomes high again, the operation is resumed. This cycle is repeated, enabling the cryogenic refrigerator CR to refrain from unnecessarily continuing to cool the object to be cooled 3, thereby effectively reducing the overall driving energy of the cryogenic refrigerator CR.

Instead of temporarily stopping operation of the cryogenic refrigerator CR, the capacity of the cryogenic refrigerator CR could be temporarily lowered by, for example, temporarily lowering the power supply frequency of the cryogenic refrigerator CR (and thus the drive motor speed of the compressor) or temporarily lowering the input power to the compressor through inverter control. However, in general, as the power supply frequency, input power to the compressor, or the like is lower (and hence as the capacity of the cryogenic refrigerator CR is lower), the drive efficiency (cooling efficiency) of the cryogenic refrigerator CR tends to decrease. Therefore, the method of temporarily reducing the capacity of cryogenic refrigerator CR as described above does not significantly reduce the overall driving energy of cryogenic refrigerator CR.

On the other hand, in the method of operation of the present embodiment, the driving energy (cooling energy) of the cryogenic refrigerator CR can be effectively reduced overall by alternately operating and stopping operation of the cryogenic refrigerator CR without reducing its capacity, and thus its operating efficiency, during operation.

The cooling system RS is not limited to the case in which stopping/starting of the operation of the cryogenic refrigerator CR is constantly repeated by the above-described method of operation. As necessary, a configuration may be adopted to switch between the case of repeatedly stopping/starting operation of the cryogenic refrigerator CR by the above-described method and the case of conventional, continuous operation of the cryogenic refrigerator CR.

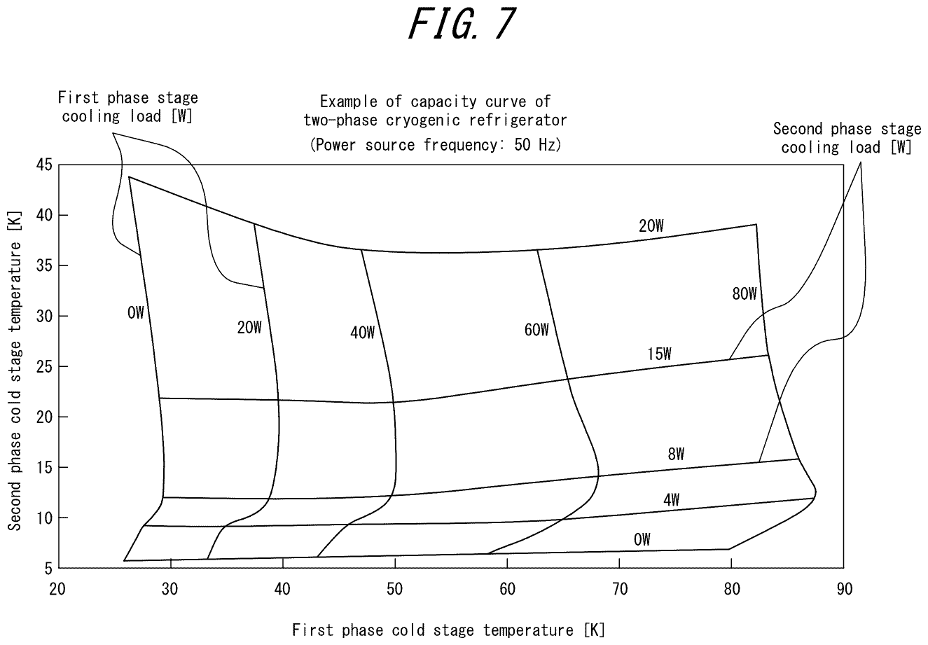

The predetermined target cooling temperature THL is preferably equal to or greater than the temperature (for example, 10 K in the example in FIG. 7) of the most downstream (most towards the tip) cold stage CRS in the cryogenic refrigerator CR (the second phase cold stage CRS2 in the present embodiment) when the cooling load of the cold stage CRS is 5 W. The predetermined target cooling temperature THL is more preferably equal to or greater than the temperature (for example, 12 K in the example in FIG. 7) of the most downstream (most towards the tip) cold stage CRS (the second phase cold stage CRS2 in the present embodiment) when the cooling load of the cold stage CRS is 8 W.

As can be seen from the example capacity curve of a cryogenic refrigerator CR illustrated in FIG. 7, in general, as the temperature (and hence the cooling temperature) of the cold stage CRS in the cryogenic refrigerator CR is lower, the cooling load (W) (and hence the cooling efficiency) of the cold stage CRS of the cryogenic refrigerator CR tends to be lower. A 0 W cooling load of the cold stage CRS means that no further cooling is possible under any conditions. FIG. 7 illustrates an example of the capacity curve of a two-phase cryogenic refrigerator CR when the power supply frequency is 50 Hz. The horizontal axis is the temperature (K) of the first phase cold stage CRS1, and the vertical axis is the temperature (K) of the second phase cold stage CRS2. Each curve that extends in a substantially vertical direction indicates the cooling load of the first phase cold stage CRS1, and each curve that extends in a substantially horizontal direction indicates the cooling load (W) of the second phase cold stage CRS2.

Therefore, by setting the predetermined target cooling temperature THL as described above, the drive efficiency (cooling efficiency) of the cryogenic refrigerator CR while operating can be maintained relatively high, and the overall driving energy (cooling energy) of the cryogenic refrigerator CR can be reduced even more effectively.

From the same perspective, the predetermined target cooling temperature THL is preferably 10 K or higher, and more preferably 12 K or higher.

The predetermined target cooling temperature THL is lower than the predetermined operation start temperature THH. The temperature obtained by subtracting the predetermined target cooling temperature THL from the predetermined operation start temperature THH (temperature difference) is preferably 20 K or higher, and more preferably 25 K or higher.

In a case in which the object to be cooled 3 is configured to include a superconducting wire as in the present embodiment (i.e., the case in which the object to be cooled 3 is the superconducting coil 3, for example), the predetermined operation start temperature THH is preferably equal to or less than, and more preferably less than, the maximum temperature at which the superconducting wire configuring the object to be cooled 3 can be made superconductive, from the perspective of maintaining the superconducting wire configuring the object to be cooled 3 in a superconductive state. The predetermined operation start temperature THH is also preferably equal to or less than, more preferably less than, the temperature at which the critical current is approximately twice the flowing current in the vertical magnetic field of the superconducting wire configuring the object to be cooled 3.

As described above, the superconducting wire configuring the object to be cooled 3 is preferably a high-temperature superconducting wire. In this case, the predetermined operation start temperature THH is preferably equal to or less than, more preferably less than, the maximum temperature at which the high-temperature superconducting wire configuring the object to be cooled 3 can be made superconductive. In general, the maximum temperature at which the high-temperature superconducting wire can be made superconductive is, for example, about 77 K, although this temperature may vary depending on the material constituting the high-temperature superconducting wire. On the other hand, the maximum temperature at which an ordinary superconducting wire (low-temperature superconducting wire) can be made superconductive is, for example, about 4 K, although this temperature may vary depending on the material constituting the low-temperature superconducting wire. The fact that the superconducting wire configuring the object to be cooled 3 is a high-temperature superconducting wire makes it possible to maintain the cooling temperature of the cryogenic refrigerator CR at a higher temperature during operation, while maintaining superconductivity of the superconducting wire configuring the object to be cooled 3, than if the superconducting wire configuring the object to be cooled 3 were a low-temperature superconducting wire. Hence, the drive efficiency (cooling efficiency) of the cryogenic refrigerator CR can be maintained higher during operation, the operation time can also be shortened, and the driving energy (cooling energy) of the cryogenic refrigerator CR can be reduced more effectively.

As described above, in the present embodiment, the thermal conduction connector TC, which connects the most downstream (most towards the tip) cold stage CRS (in the present embodiment, the second phase cold stage CRS2) in the cryogenic refrigerator CR with the object to be cooled 3 in a thermally conductive manner, has the cold storage body 22 (FIG. 2). In other words, the cold storage body 22 is connected to the cold stage CRS and the object to be cooled 3 in a thermally conductive manner.

The cold storage body 22 is made of a metal or other thermal conductor and is configured to be capable of storing part of the cold (sensible heat) generated in the most downstream (most towards the tip) cold stage CRS (in the present embodiment, the second phase cold stage CRS2) in the cryogenic refrigerator CR. As described above, in the present embodiment, the cold storage body 22 is the split core 22 or the core member 22 and is configured to include iron.

The inclusion of the cold storage body 22 enables the cold storage body 22 to store a portion of the cold generated from the most downstream (most towards the tip) cold stage CRS (in the present embodiment, the second phase cold stage CRS2) while the cryogenic refrigerator CR is operating, and then while operation of the cryogenic refrigerator CR is stopped, to continue cooling the object to be cooled 3 using the cold that the cold storage body 22 has stored up until then. As a result, a rise in temperature of the object to be cooled 3 can be suppressed while operation of the cryogenic refrigerator CR is stopped, which in turn increases the operation stopping time of the cryogenic refrigerator CR and reduces the number of times that operation of the cryogenic refrigerator CR is started and stopped (ON/OFF). This can suppress the load that may be placed on the electric components and the like of the cooling system RS due to repetitive starting and stopping (ON/OFF) of operation of the cryogenic refrigerator CR, thereby improving the service life of the cooling system RS.

However, the cold storage body 22 need not be provided.

The heat capacity (sensible heat capacity) of the cold storage body 22 is preferably larger than that of the object to be cooled 3. In general, as the heat capacity is larger, the ability to store cold (cold storage performance) tends to be higher. Therefore, if the cold storage body 22 has a larger heat capacity (sensible heat capacity) than the object to be cooled 3, the cold storage performance of the cold storage body 22 can be improved, which can further suppress a rise in temperature of the object to be cooled 3 while operation of the cryogenic refrigerator CR is stopped. This in turn can increase the operation stopping time of the cryogenic refrigerator CR and further reduce the number of times that operation of the cryogenic refrigerator CR is started and stopped (ON/OFF).

From the same perspective, the volume of the cold storage body 22 is preferably larger than that of the object to be cooled 3.

As described above, in the present embodiment, the thermal conduction connector TC, which connects the most downstream (most towards the tip) cold stage CRS (in the present embodiment, the second phase cold stage CRS2) in the cryogenic refrigerator CR with the object to be cooled 3 in a thermally conductive manner, has one or more (in the present embodiment, four) heat equalizing members SK (FIGS. 2, 4, 5). In other words, one or more (in the present embodiment, four) heat equalizing members SK are connected to the cold stage CRS and the object to be cooled 3 in a thermally conductive manner.

The heat equalizing members SK have the function of quickly and evenly transferring cold to the cold storage body 22. The heat equalizing members SK are made of a metal or other thermal conductor and are preferably made of copper (for example, pure copper (oxygen-free copper)) from the perspectives of thermal conductivity, availability, workability, price, and the like. The heat equalizing members SK are preferably configured in the form of a plate, as in the present embodiment, as this facilitates even transmission of cold.

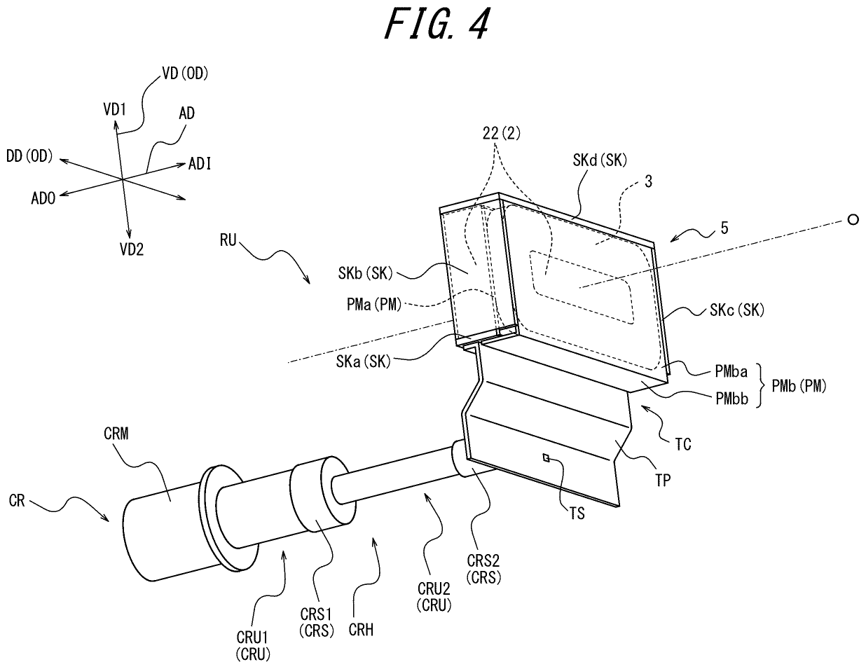

As illustrated in FIGS. 4 and 5, in the present embodiment, the one or more (in the present embodiment, four) heat equalizing members SK surround the cold storage body 22 in a ring, specifically contacting the cold storage body 22 over the entire outer circumferential surface of the cold storage body 22.

More specifically, in the present embodiment, the cold storage body 22 has a substantially cuboid shape with the axis O as the central axis, and the four sides 224 of the cold storage body 22 are located on the periphery of the axis O, as illustrated in FIG. 5. The first side 224a and the fourth side 224d of the four sides 224 of the cold storage body 22 are parallel to the axial direction AD and the depth direction DD. The first side 224a is located toward the longitudinal direction second side VD2 from the fourth side 224d. The first side 224a faces the longitudinal direction second side VD2 (the bottom in the present embodiment), and the fourth side 224d faces the longitudinal direction first side VD1 (the top in the present embodiment). The second side 224b and the third side 224c of the four sides 224 of the cold storage body 22 are parallel to the axial direction AD and the longitudinal direction VD and are separated from each other in the depth direction DD. The second side 224b and the third side 224c each face the opposite side from the axis O in the depth direction DD.

In the present embodiment, the four heat equalizing members SK each have the form of a plate and are each in contact with the periphery of the four sides 224 of the cold storage body 22. The first heat equalizing member SKa and the fourth heat equalizing member SKd of the four heat equalizing members SK are oriented parallel to the first side 224a and the fourth side 224d of the cold storage body 22 and are in contact (surface contact) with the first side 224a and the fourth side 224d of the cold storage body 22, respectively. The second heat equalizing member SKb and the third heat equalizing member SKc of the four heat equalizing members SK are oriented parallel to the second side 224b and the third side 224c of the cold storage body 22 and are in contact (surface contact) with the second side 224b and the third side 224c of the cold storage body 22, respectively. These four heat equalizing members SK are in contact with each other at their respective ends. The four heat equalizing members SK thereby form an annular shape.

In the present embodiment, the one or more (in the present embodiment, four) heat equalizing members SK are in contact with the cold storage body 22 over the entire outer circumferential surface of the cold storage body 22. These heat equalizing members SK can thereby quickly and evenly transfer the cold transmitted from the cryogenic refrigerator CR side to the cold storage body 22 over the entire circumference thereof (in other words, heat equalization of the cold storage body 22 is facilitated), and rapid temperature changes can be suppressed, enabling stable cold storage by the cold storage body 22. This can achieve more effective and stable cold storage by the cold storage body 22 while the cryogenic refrigerator CR is operating.

The cold storage body 22 and the heat equalizing member SK may, however, have any shape.

The one or more heat equalizing members SK may be in contact with any part of the cold storage body 22.

As illustrated in FIGS. 1 and 2, in the present embodiment, the cold head CRH of the cryogenic refrigerator CR extends in the axial direction AD. The tip of the cold head CRH faces the axial direction inside ADI.

However, the cold head CRH of the cryogenic refrigerator CR may be oriented in any direction.

As illustrated in FIGS. 1 and 2, in the present embodiment, the split core coil assembly 5 is located farther toward the longitudinal direction first side VD1 than the cold head CRH. Also, in the present embodiment, the split core coil assembly 5 is located farther toward the axial direction inside ADI than the cold head CRH.

However, the cold head CRH of the cryogenic refrigerator CR and the split core coil assembly 5 may have any positional relationship.

As described above, in the present embodiment, the thermal conduction connector TC, which connects the most downstream (most towards the tip) cold stage CRS (in the present embodiment, the second phase cold stage CRS2) in the cryogenic refrigerator CR with the object to be cooled 3 in a thermally conductive manner, has one or more (in the present embodiment, one) thermal conduction member TP. In other words, one or more (in the present embodiment, one) thermal conduction members TP are connected to the cold stage CRS and the object to be cooled 3 in a thermally conductive manner.

The thermal conduction member TP is made of a metal or other thermal conductor and is preferably made of copper (for example, pure copper (oxygen-free copper)) from the perspectives of thermal conductivity, availability, workability, price, and the like. The thermal conduction member TP is preferably configured in the form of a plate, as in the present embodiment, as this facilitates even transmission of cold.

More specifically, the thermal conduction member TP is in contact with the most downstream (most towards the tip) cold stage CRS (in the present embodiment, the second phase cold stage CRS2) in the cryogenic refrigerator CR and at least one (in the present embodiment, the first heat equalizing member SKa) of the one or more (in the present embodiment, four) heat equalizing members SK (FIG. 2) and hence connects these components in a thermally conductive manner. This enables the cold generated from the cold stage CRS to be transferred to at least one of the one or more (in the present embodiment, four) heat equalizing members SK (in the present embodiment, the heat equalizing members SKa) via the thermal conduction member TP.

In the present embodiment, the thermal conduction member TP extends substantially along the longitudinal direction VD, the lower end of the thermal conduction member TP is in contact (surface contact) with the tip surface of the most downstream (most towards the tip) cold stage CRS (in the present embodiment, the second phase cold stage CRS2) in the cryogenic refrigerator CR, and the upper end of the thermal conduction member TP is in contact (surface contact) with at least one (in the present embodiment, the first heat equalizing member SKa) of the one or more (in the present embodiment, four) heat equalizing members SK (FIG. 2).

However, the thermal conduction member TP may have any shape and extending direction.

The thermal conduction member TP need not be provided. For example, the most downstream (most towards the tip) cold stage CRS (in the present embodiment, the second phase cold stage CRS2) in the cryogenic refrigerator CR may be in direct contact with the one or more (in the present embodiment, four) heat equalizing members SK.

As described above, in the present embodiment, the thermal conduction connector TC, which connects the most downstream (most towards the tip) cold stage CRS (in the present embodiment, the second phase cold stage CRS2) in the cryogenic refrigerator CR with the object to be cooled 3 in a thermally conductive manner, has one or more (in the present embodiment, two) cooling conduction members PM. In other words, one or more (in the present embodiment, two) cooling conduction members PM are connected to the cold stage CRS and the object to be cooled 3 in a thermally conductive manner. More specifically, the one or more (in the present embodiment, two) cooling conduction members PM are each in contact with at least one of the one or more (in the present embodiment, four) heat equalizing members SK and with the object to be cooled 3.

The cooling conduction members PM are made of a metal or other thermal conductor and are preferably made of copper (for example, pure copper (oxygen-free copper)) from the perspectives of thermal conductivity, availability, workability, price, and the like. The cooling conduction members PM are preferably configured in the form of a plate, as in the present embodiment, as this facilitates even transmission of cold.

More specifically, the thermal conduction connector TC has a first cooling conduction member PMa and a second cooling conduction member PMb each as a cooling conduction member PM.

The first cooling conduction member PMa is arranged between the cold storage body 22 and the object to be cooled 3 in the axial direction AD and is in contact (surface contact) with the cold storage body 22 and the object to be cooled 3.

More specifically, in the present embodiment, as illustrated in FIGS. 1, 2, and 5, the outer circumferential surface 221 of the cold storage body 22 has an annular step 2211. The step 2211 extends over the entire circumference in the circumferential direction centered on the axis O. The step 2211 faces the axial direction inside ADI. The step 2211 is concave inward in the axial orthogonal direction. Specifically, the step 2211 is formed by an axial orthogonal face 2211a that is substantially parallel to the axial orthogonal direction OD and faces the axial direction inside ADI, and an axial direction face 2211b that extends, in a direction substantially parallel to the axial direction AD, from the axial orthogonal face 2211a to the end face 223 of the cold storage body 22 on the axial direction inside ADI. The object to be cooled 3 is configured in an annular shape extending over the entire circumference in the circumferential direction centered on the axis O and is arranged within the step 2211. Specifically, the object to be cooled 3 is wrapped around the step 2211 along the circumferential direction centered on the axis O.

On the other hand, the first cooling conduction member PMa is configured in an annular shape extending over the entire circumference in the circumferential direction around the axis O. The surface of the first cooling conduction member PMa on the axial direction outside ADO is in contact with the axial orthogonal face 2211a of the step 2211 of the cold storage body 22, and the surface of the first cooling conduction member PMa on the axial direction inside ADI is in contact with the surface of the object to be cooled 3 on the axial direction outside ADO. The axial direction face 2211b of the step 2211 is located on the inner circumferential side of the first cooling conduction member PMa and the object to be cooled 3. At least one of the heat equalizing members SK (in the present embodiment, the second heat equalizing member SKb, the third heat equalizing member SKc, and the fourth heat equalizing member SKd) extends beyond the axial orthogonal face 2211a of the step 2211 of the cold storage body 22 toward the axial direction inside ADI. At least one of the heat equalizing members SK (in the present embodiment, the first heat equalizing member SKa, the second heat equalizing member SKb, and the third heat equalizing member SKc) is in contact with the first cooling conduction member PMa.

As illustrated in FIG. 6, the first cooling conduction member PMa and at least one of the heat equalizing members SK in contact with the first cooling conduction member PMa (in the present embodiment, the first heat equalizing member SKa) may be fixed to each other by a fixing member F, such as a screw. In the present embodiment, the end face of the first heat equalizing member SKa on the axial direction inside ADI is located at substantially the same position in the axial direction AD as the axial orthogonal face 2211a of the step 2211 of the cold storage body 22. The first cooling conduction member PMa is in contact, from the axial direction inside ADI, with the end face of the first heat equalizing member SKa on the axial direction inside ADI farther toward the longitudinal direction second side VD2 than the object to be cooled 3. At this location, the first cooling conduction member PMa is fixed to the first heat equalizing member SKa by the fixing member F.

The second cooling conduction member PMb is arranged on the axial direction inside ADI of the object to be cooled 3 and is in contact (surface contact) with the object to be cooled 3.

More specifically, in the present embodiment, as illustrated in FIGS. 1, 2, and 5, the second cooling conduction member PMb is formed by an axial orthogonal plate-shaped portion PMba substantially parallel to the axial orthogonal direction OD and an axial direction plate-shaped portion PMbb extending toward the axial direction outside ADO from the end of the axial orthogonal plate-shaped portion PMba on the longitudinal direction second side VD2.

The surface of the object to be cooled 3 on the axial direction inside ADI and the end face 223 of the cold storage body 22 on the axial direction inside ADI are flush. The face of the axial orthogonal plate-shaped portion PMba of the second cooling conduction member PMb on the axial direction outside ADO is in contact with the surface of the object to be cooled 3 on the axial direction inside ADI and the end face 223 of the cold storage body 22 on the axial direction inside ADI.

The axial direction plate-shaped portion PMbb of the second cooling conduction member PMb is located on the longitudinal direction second side VD2 of the first heat equalizing member Ska, and the surface of the axial direction plate-shaped portion PMbb of the second cooling conduction member PMb on the longitudinal direction first side VD1 is in contact with the surface of the first heat equalizing member Ska on the longitudinal direction second side VD2. The axial direction plate-shaped portion PMbb of the second cooling conduction member PMb is located farther toward the axial direction inside ADI than the thermal conduction member TP. In the present embodiment, the axial direction plate-shaped portion PMbb of the second cooling conduction member PMb is separated from the thermal conduction member TP, but the axial direction plate-shaped portion PMbb of the second cooling conduction member PMb may be in contact with the thermal conduction member TP.

The second cooling conduction member PMb need not have the axial direction plate-shaped portion PMbb.

In this way, the one or more (in the present embodiment, two) cooling conduction members PM are each in contact with at least one of the one or more (in the present embodiment, four) heat equalizing members SK and with the object to be cooled 3. Therefore, while the cryogenic refrigerator CR is operating, the cold transmitted from the cryogenic refrigerator CR side via the heat equalizing members SK can be transmitted to the object to be cooled 3 via each of the cooling conduction members PM. As a result, the object to be cooled 3 can be cooled more evenly and efficiently.

While operation of the cryogenic refrigerator CR is stopped, the cold stored in the cold storage body 22 is transmitted to the object to be cooled 3 via the first cooling conduction member PMa.

Each cooling conduction member PM may, however, have any shape, position, and the like as long as contact is made with the heat equalizing member SK and the object to be cooled 3.

From the perspective of ensuring that cold is efficiently transmitted from the heat equalizing member SK to the object to be cooled 3 via the cooling conduction member PM, each cooling conduction member PM is preferably in contact with at least one heat equalizing member SK and in contact (surface contact) with an end face on either side of the object to be cooled 3 in the axial direction AD, as in the present embodiment. This increases the contact area between the cooling conduction member PM and the object to be cooled 3, which in turn transmits cold more efficiently from the heat equalizing member SK to the object to be cooled 3 via the cooling conduction member PM.

The radiation shield SH has a radiation shield space SHR partitioned therein. The object to be cooled 3, a portion of the cryogenic refrigerator CR, the thermal conduction connector TC, and the temperature sensor TS are arranged inside the radiation shield space SHR. In the present embodiment, the radiation shield SH is connected to (in contact with) the first phase cold stage CRS1 of the cryogenic refrigerator CR. The cold generated in the first phase cold stage CRS1 can thereby be transferred to the radiation shield SH. The radiation shield SH is configured to inhibit radiation heat originating outside the radiation shield SH from entering the radiation shield space SHR. The portion (in the present embodiment, the second phase cold unit CRU) of the cold head CRH of the cryogenic refrigerator CR that is downstream (toward the tip) from the first phase cold stage CRS1 is arranged inside the radiation shield space SHR.

The radiation shield SH preferably has laminated insulation on a portion or all of the walls thereof (for example, the outer surface). The laminated insulation is, for example, configured by a plurality of layers of metallized resin film and resin mesh. Examples of materials that may configure the body of the vacuum insulation container 4 include austenitic stainless steel and composite glass fiber reinforced plastic (GFRP).

However, the radiation shield SH need not be provided.

In the cooling system RS and magnetic field generator 1 of the present embodiment, the magnetic field generator 1 includes the superconducting coils 3 and can therefore generate a stronger magnetic field in the working space 6 than if the magnetic field generator 1 included ordinary copper coils instead of the superconducting coils 3.

Also, the magnetic field generator 1 includes the cores 2. Therefore, according to the magnetic field generator 1 of the present embodiment, a stronger magnetic field can be generated, while reducing the amount of superconductor used in the production of the superconducting coil 3, than if the magnetic field generator 1 did not include the cores 2. The amount of superconductor is thus reduced, thereby reducing costs. Since superconductors are generally expensive, the reduction in the amount of superconductor has a considerable effect on cost reduction.

The core 2 of the magnetic field generator 1 includes the yoke 21. Therefore, according to the present embodiment, the magnetic circuit resistance can be reduced and the magnetic flux can be increased as compared to a case in which the core 2 does not have the yoke 21.

According to the present embodiment, as described above, the core 2 is divided into the yoke 21 and the pair of split cores 22, each split core coil assembly 5 is housed in the respective vacuum insulation container 4, and the yoke 21 is arranged outside the pair of vacuum insulation containers 4. Therefore, the vacuum insulation container 4 can be reduced in size as compared to a case in which the entirety of an undivided, substantially C-shaped core and pair of superconducting coils wound around the pair of ends of the core is housed in a vacuum insulation container. This reduces heat penetration from the outside, which in turn enables energy saving.

If a substantially C-shaped core that is not divided were used, then in order to reduce the size of the vacuum insulation container, the vacuum insulation container could be configured as a donut-type container, so that the vacuum insulation container only houses a pair of superconducting coils that surround the pair of ends of the core. However, in such a case, a wall of the vacuum insulation container would be interposed between the core and the superconducting coils, i.e., the core and the superconducting coils would be separated from each other. The circumference of the superconducting coils would correspondingly increase, thereby increasing the amount of superconducting coils used and leading to higher costs. In addition, the separation between the core and the superconducting coil yields a corresponding increase in leakage flux, thereby increasing the necessary amount of superconductor and leading to increased costs. In this respect, according to the present embodiment, the superconducting coils 3 are wound directly on the cores 2 (specifically, the split cores 22) without the intermediate presence of the wall of the vacuum insulation container, and hence the cores 2 (specifically, the split cores 22) and the superconducting coils 3 are in contact, eliminating the distance between them. As a result, the circumference of the superconducting coils 3 can be shortened as compared to the case of a donut-type vacuum insulation container, as described above. The amount of superconductor is thereby reduced, which reduces costs. Also, since the cores 2 (specifically, the split cores 22) and the superconducting coils 3 are in contact, eliminating the distance between them, leakage flux can be reduced as compared to the case of a donut-type vacuum insulation container, as described above. The amount of superconductor is thereby reduced, which reduces costs. In addition, since the core 2 (specifically, the split core 22) is in contact with the superconducting coil 3 (via the cooling conduction member PM), a rise in temperature of the superconducting coil 3 can be suppressed by using the cold storage effect of the core 2 (specifically, the split core 22), as compared to the case of a donut-type vacuum insulation container, as described above. The cooling burden of the cryogenic refrigerator CR can therefore be reduced, and the capacity of the superconductor can be effectively utilized by being able to cool the superconducting coils sufficiently.

Also, as illustrated in FIG. 6, in each split core coil assembly 5, the Lorentz force (black arrow in FIG. 6) acting on the superconducting coil 3 toward the axial direction outside ADO and the electromagnetic force (white arrow in FIG. 6) acting on the split core 22 toward the axial direction inside ADI when the power is on cancel each other out in the present embodiment. The force acting on the split core coil assembly 5 in the axial direction AD consequently decreases. The support structure for supporting the split core coil assembly 5 against the vacuum insulation container 4 can therefore be simplified. Furthermore, the heat penetration from the outside into the superconducting coil 3 through the support structure can be reduced, which in turn reduces the cooling burden of the cryogenic refrigerator CR and enables effective use of the capacity of the superconductor by achieving sufficient cooling of the superconducting coil.

In the present embodiment, as illustrated in FIGS. 1, 2, and 6, the cooling system RS and the magnetic field generator 1 have a support member 7 as a support structure for supporting the split core coil assembly 5 against the vacuum insulation container 4. The support member 7 is configured to suspend the split core coil assembly 5 from the vacuum insulation container 4. More specifically, in the present example, the support member 7 is, for example, configured as a rod having low thermal conductivity, to insulate and suspend the split core coil assembly 5 from the upper (longitudinal direction first side VD1) wall 41 in the vacuum insulation container 4. The support member 7 is thus configured to support the weight of the split core coil assembly 5 and is not configured to regulate the horizontal movement of the split core coil assembly 5. In this way, the support structure (support member 7) for supporting the split core coil assembly 5 against the vacuum insulation container 4 has a simple configuration in the present embodiment.

The support structure for supporting the split core coil assembly 5 against the vacuum insulation container 4 is not limited to this example, and any support structure may be adopted.

In the present embodiment, as illustrated in FIGS. 1, 2, and 6, the cooling system RS and the magnetic field generator 1 have spacer members 8 between the split core coil assembly 5 and the walls 42 and 43 (FIG. 6) of the vacuum insulation container 4 on both sides in the axial direction AD. This enables more effective suppression of excessive movement of the split core coil assembly 5 in the axial direction AD at times such as when the power is on. In addition, the spacer members 8 maintain a gap between the split core coil assembly 5 and the vacuum insulation container 4 when the power is not on, thereby reducing the amount of heat penetration when the power is suspended.

The spacer members 8 may, for example, be configured to be fixed to or integral with the split core 22 of the split core coil assembly 5, and to be separate from and not fixed to the walls 42 and 43 of the vacuum insulation container 4 on both sides in the axial direction AD. Alternatively, the spacer members 8 may be separate from and not fixed to the split core coil assembly 5, and fixed to or configured integrally with the walls 42 and 43 of the vacuum insulation container 4 on both sides in the axial direction AD.

The spacer members 8 need not be provided.

As described above, in the present embodiment, in each of the split core coil assemblies 5 in the pair thereof, as illustrated in FIGS. 1, 2, 5, and 6, the outer circumferential surface 221 of the split core 22 has the annular step 2211. The step 2211 extends over the entire circumference in the circumferential direction centered on the axis O. The step 2211 faces the working space 6 (with the wall 42 of the vacuum insulation container 4 therebetween). The step 2211 is concave inward in the axial orthogonal direction. Specifically, the step 2211 is formed by the axial orthogonal face 2211a that is substantially parallel to the axial orthogonal direction OD and faces the axial direction inside ADI, and the axial direction face 2211b that extends from the axial orthogonal face 2211a to the end face 223 of the split core 22 on the axial direction inside ADI. The superconducting coil 3 is wound around the step 2211 in the circumferential direction centered on the axis O.

The superconducting coil 3 and the split core 22 are thereby made to face each other in the axial direction AD. Consequently, the Lorentz force acting on the superconducting coil 3 toward the axial direction outside ADO (black arrow in FIG. 6) and the electromagnetic force acting on the split core 22 toward the axial direction inside ADI (white arrow in FIG. 6) more effectively cancel each other out, and the force in the axial direction AD acting on the split core coil assembly 5 becomes smaller. The support structure for supporting the split core coil assembly 5 against the vacuum insulation container 4 can therefore be further simplified. Although the Lorentz force (black arrow in FIG. 6) acts on the superconducting coil 3 toward the axial direction outside ADO, the movement of the superconducting coil 3 toward the axial direction outside ADO is regulated by the step 2211 (especially by the axial orthogonal face 2211a). In other words, the step 2211 has the function of regulating movement of the superconducting coil 3 toward the axial direction outside ADO. Therefore, it is not necessary to separately provide a regulatory structure to regulate the movement of the superconducting coil 3 toward the axial direction outside ADO. Furthermore, the heat penetration from the outside into the superconducting coil 3 through the regulatory structure can be reduced, which in turn suppresses a rise in temperature of the superconducting coil 3, thereby reducing the cooling burden of the cryogenic refrigerator CR and enabling effective use of the capacity of the superconductor by achieving sufficient cooling of the superconducting coil. Also, the superconducting coil 3 is not covered by the split core 22 on the axial direction inside ADI thereof, but rather faces the working space 6 (through the wall 42 of the vacuum insulation container 4) and can consequently generate a stronger magnetic field in the working space 6. In addition, since the superconducting coil 3 is in contact not only with the axial direction face 2211b of the step 2211 but also with the axial orthogonal face 2211a of the step 2211, the contact area with the split core 22 is correspondingly increased, which in turn improves the cooling effect of the superconducting coil 3 through the split core 22.

The above-described step 2211 is preferably provided in both of the split core coil assemblies 5 but may instead be provided in only one of the two split core coil assemblies 5.

In each of the examples described in the present specification, in at least one of the pair of split core coil assemblies 5, the outer circumferential surface 31 of the superconducting coil 3 may be at the same axial orthogonal direction OD position as the outer circumferential surface 221 of the split core 22, as in the example illustrated in FIG. 6. Alternatively, while omitted from the drawings, the outer circumferential surface 31 may be further circumferentially inward or outward than the outer circumferential surface 221 of the split core 22.

In each of the examples described in the present specification, while omitted from the drawings, in at least one of the pair of split core coil assemblies 5, the outer circumferential surface 221 of the split core 22 may have a projection protruding circumferentially outward, and the projection may have the step 2211. In this case, the outer circumferential surface 31 of the superconducting coil 3 may be at the same axial orthogonal direction OD position as the outer circumferential surface of the projection or may be further circumferentially inward than the outer circumference of the projection or further circumferentially outward than the outer circumferential surface of the projection.

While omitted from the drawings, in at least one of the pair of split core coil assemblies 5, the outer circumferential surface 221 of the split core 22 may have an annular groove. The groove extends over the entire circumference in the circumferential direction centered on the axis O. The outer circumferential side of the groove is open. The groove has a pair of groove walls that face each other and are each substantially parallel to the axial orthogonal direction OD and a groove bottom surface that faces the outer circumferential side and is substantially parallel to the axial direction AD. In this case, the superconducting coil 3 is wound along the circumferential direction in the groove and is thereby accommodated in the groove.

However, in at least one of the pair of split core coil assemblies 5, the superconducting coil 3 may be wound on the outer circumferential surface 221 of a split core 22 having no unevenness such as the step 2211 or groove. In this case as well, the Lorentz force acting on the superconducting coil 3 toward the axial direction outside ADO and the electromagnetic force acting on the split core 22 toward the axial direction inside ADI cancel each other out, reducing the force in the axial direction AD acting on the split core coil assembly 5. The support structure for supporting the split core coil assembly 5 against the vacuum insulation container 4 can therefore be simplified.

However, as in each of the examples described above, this effect is greater when the superconducting coil 3 is wound around the step 2211 or groove on the outer circumferential surface 221 of the split core 22. When the superconducting coil 3 is wound on the outer circumferential surface 221 of a split core 22 having no unevenness such as the step 2211 or groove, a regulatory structure to regulate the movement of the superconducting coil 3 toward the axial direction outside ADO is preferably provided separately.

In each of the examples described in the present specification, in at least one of the pair of split core coil assemblies 5, the superconducting coil 3 may be formed by a single-stage structure consisting of only one layer along the axial direction AD, as in the examples illustrated in FIGS. 1 to 6. Alternatively, while omitted from the drawings, the superconducting coil 3 may be formed by a multi-stage structure with a plurality of superconducting coil layers arrayed along the axial direction AD.

In each of the examples described in the present specification, the end 21a of the yoke 21 and the wall 43 of the vacuum insulation container 4 on the axial direction outside ADO are preferably spaced apart from each other, as illustrated in FIG. 6, but these may be in contact with each other.

In each of the examples described in the present specification, the configuration of the vacuum insulation container 4 and the split core coil assembly 5 is preferably symmetrical with respect to the center of the axial direction AD of the cooling system RS and the magnetic field generator 1, but the configuration may be asymmetrical with respect to the center of the axial direction AD of the cooling system RS and the magnetic field generator 1.

In each of the examples described in the present specification, the cooling system RS and the magnetic field generator 1 may be configured to include only one vacuum insulation container 4. In this case, the pair of split core coil assemblies 5 are housed in the vacuum insulation container 4, and the yoke 21 is arranged outside of the vacuum insulation container 4. In this case as well, the vacuum insulation container 4 can be reduced in size as compared to a case in which the entirety of an undivided, substantially C-shaped core and pair of superconducting coils wound around the pair of ends of the core is housed in a vacuum insulation container.

The vacuum insulation container 4 in this case may, for example, have a configuration in which the pair of vacuum insulation containers 4 in the example in FIG. 1 are connected by a connecting tube or the like to be configured integrally.

In the embodiments described above, each cooling unit RU includes only one temperature sensor TS. However, the cooling unit RU may include a plurality of temperature sensors TS. In this case as well, each temperature sensor TS of the cooling unit RU is configured to detect the temperature of any one of the object to be cooled 3, any one of the cold stages CRS of the cryogenic refrigerator CR, the thermal conduction connector TC, and the current leads D1, D2. In this case, each temperature sensor TS is preferably configured to detect the temperature of a different part. The controller PS then performs an operation stop process to stop operation of the cryogenic refrigerator CR in a case in which, while the cryogenic refrigerator CR is operating, the temperature detected by any one predetermined temperature sensor TS drops to a predetermined target cooling temperature THL (operation stop step). The controller PS performs an operation start process to start operation of the cryogenic refrigerator CR in a case in which, while operation of the cryogenic refrigerator CR is stopped, the temperature detected by any one predetermined temperature sensor TS rises to a predetermined operation start temperature THH that is higher than the predetermined target cooling temperature THL (operation start step). The same predetermined temperature sensor TS or different predetermined temperature sensors TS may be used in the operation stop step and the operation start step.

Here, a supplemental explanation of the predetermined operation start temperature THH is provided.

In general terms, high-temperature superconducting wires attain superconductivity at the liquid nitrogen temperature level, but materials such as magnesium diboride (MgB₂) that exhibit superconductivity at intermediate temperatures levels between liquid helium and liquid nitrogen also exist and are classified as high-temperature superconducting wires.

The minimum cooling temperature (Tc critical temperature) of a high-temperature superconducting wire depends on the following conditions.
(1) Material manufacturing processes and variations thereof
(2) Magnetic field strength of operating environment
(3) Flowing current

Generally, once the condition (1) above is determined, conditions (2) and (3), which are linked to each other, are determined, and the necessary cooling temperature is determined based on the results of the three conditions.

However, it is difficult to intentionally determine the cooling temperature. Conventionally, when it was necessary to set the cooling temperature, the cryogenic refrigerator CR was used to cool to a temperature equal to or less than the set temperature, and current was fed to a heater wound around the cold head CRH to raise the temperature to a predetermined temperature (control by a thermostat).

The predetermined operation start temperature THH is preferably set to a lower temperature than the critical temperature determined from (1), (2), and (3) above, taking into account the start-up time of the refrigerator and temperature error.

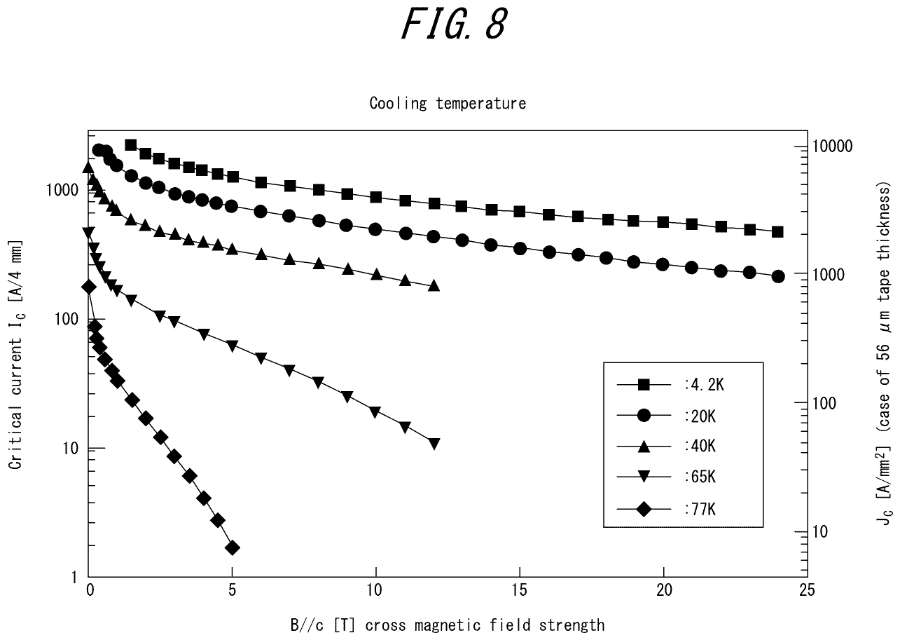

FIG. 8 illustrates an example of the critical current characteristics of a REBCO wire, which is a type of high-temperature superconducting wire. In the example in FIG. 8, the predetermined operation start temperature THH is, for example, preferably set to approximately 45 K for a current of 300 A and a critical temperature of 50 K in the superconducting coil 3.

In addition, in the case of a two-phase cryogenic refrigerator CR as in the embodiment in FIG. 1, the high-temperature end D2a of the second current lead D2 is preferably cooled in the first phase cold stage CRS1, and the rise in temperature due to intrusive heat entering the first phase cold stage CRS1 preferably reaches the limit later than the rise in temperature on the superconducting coil 3 side does. If the limit is reached earlier, operation of the cryogenic refrigerator CR is preferably started under the temperature conditions of the first phase cold stage CRS1. Accordingly, one temperature sensor TS may be configured to detect the temperature of the first phase cold stage CRS1, for example, and operation of the cryogenic refrigerator CR may be started when the temperature detected by that temperature sensor TS rises to the predetermined operation start temperature THH.

Next, a supplemental explanation of the predetermined target cooling temperature THL is provided.

Since the temperature of the superconducting coil 3 after operation of the cryogenic refrigerator CR starts is always a temperature that satisfies the superconducting condition, the predetermined target cooling temperature THL can be determined under completely different conditions than the maintenance of the superconducting condition.

After operation of the cryogenic refrigerator CR starts, the cryogenic refrigerator CR cools the superconducting coil 3 itself and the sensible heat of incidental materials, in addition to several watts of external heat due to radiation, conduction, and the like, which are approximately fixed values. The cooling temperature gradually decreases, and as the cooling temperature decreases, the efficiency of the refrigerator decreases. The cooling capacity may settle at a temperature balanced with the external heat, and cooling to a lower temperature may become impossible.

If only maintenance of the superconducting state is considered, it is possible to stop operation of the cryogenic refrigerator CR at any temperature between this balance temperature and the predetermined operation start temperature THH. However, if the predetermined target cooling temperature THL is increased, the time until starting operation after operation is stopped and until stopping operation after operation is started becomes shorter, and the ON/OFF frequency of the cryogenic refrigerator CR increases. The increase in the ON/OFF frequency of the cryogenic refrigerator CR may adversely affect the mechanical service life of the cryogenic refrigerator CR and related equipment. The predetermined target cooling temperature THL could therefore be lowered, but the decrease in efficiency of the cryogenic refrigerator CR would require time to accumulate cooling energy by sensible heat in the cold storage body 22. Consequently, the cooling time by sensible heat of the cold storage body 22 after operation of the cryogenic refrigerator CR is stopped could increase.

The predetermined target cooling temperature THL is preferably set equal to or greater than the balance point between the operating time due to the cold storage amount and the time required for the cold storage amount.

Operation by stored cold can be considered as cooling of the external intrusive heat by cold storage. The reference point for the predetermined target cooling temperature THL can thus be considered as, for example, the point at which the cooling capacity is twice the external intrusive heat. At this reference temperature, a significant amount of cooling heat is required, so the temperature is higher than the lowest temperature attained by the cryogenic refrigerator CR under no-load cooling conditions.

For example, if the external intrusive heat is 4 W, then the reference point for the predetermined target cooling temperature THL is preferably approximately 15 K, which is the point at which the capacity of the second phase cold stage CRS2 of the cryogenic refrigerator CR is 8 W. In this case, it is considered possible to maximize the times for starting and stopping operation of the cryogenic refrigerator CR while reducing the power consumption of the cryogenic refrigerator CR.

At temperatures equal to or greater than the reference point, the time required to reach the predetermined operation start temperature THH becomes shorter due to the increased capacity of the cryogenic refrigerator CR, but the ratio of stopped time to operation time of the cryogenic refrigerator CR becomes larger due to the increased cold storage per unit time, which is considered to save more energy.

In summary, the following assertions can be made.
(a) The predetermined operation start temperature THH is preferably set to a lower value at which a necessary margin is maintained with respect to the critical temperature standard based on the current conditions and the cross magnetic field strength for the usage characteristics of the wire material used.
(b) The predetermined target cooling temperature THL is preferably set taking the cooling capacity of the cryogenic refrigerator CR at twice the external intrusive heat and the cooling temperature at that time as a standard.
(c) It is preferable to take into consideration that if the predetermined target cooling temperature THL is higher than the standard, the utilization rate of the cryogenic refrigerator CR increases, but the ON/OFF frequency increases, which adversely affects the service life of mechanical parts.
(d) In the case of a two-phase cryogenic refrigerator CR, the cooling temperature conditions of the first phase cold stage CRS1, in particular the temperature of the high-temperature end D2a of the second current lead D2, preferably do not exceed the allowable range, but in the case of exceeding, the cryogenic refrigerator CR is preferably operated under these conditions.

### INDUSTRIAL APPLICABILITY

The cooling system and the method of operation according to the present disclosure can be used to cool any object to be cooled and can be suitably used, for example, to cool superconducting coils. The cooling system and the method of operation according to the present disclosure can also be used in any device and can be used, for example, in a magnetic field generator.

The magnetic field generator according to the present disclosure can be used for any application and can be used, for example, in an aluminum billet heating device.

### REFERENCE SIGNS LIST

RS Cooling system
RU Cooling unit
CR Cryogenic refrigerator
CRM Motor
CRH Cold head
CRU Cold unit
CRU1 First phase cold unit
CRU2 Second phase cold unit
CRC Cylinder
CRD Displacer
CRL Cold storage material
CRF Sealing member
CRR Expansion chamber
CRV Sleeve
CRS Cold stage
CRS1 First phase cold stage
CRS2 Second phase cold stage
TS Temperature sensor
PS Controller
TC Thermal conduction connector
SK Heat equalizing member
SKa First heat equalizing member
SKb Second heat equalizing member
SKc Third heat equalizing member
SKd Fourth heat equalizing member
PM Cooling conduction member
PMa First cooling conduction member
PMb Second cooling conduction member
PMba Axial orthogonal plate-shaped portion
PMbb Axial direction plate-shaped portion
TP Thermal conduction member
SH Radiation shield
SHR Radiation shield space
F Fixing member
D1 First current lead (current lead)
D2 Second current lead (current lead)
D2a High-temperature end
D2b Low-temperature end
E Hermetic feed-through terminal
BB1 First bus bar
BB2 Second bus bar
1 Magnetic field generator
2 Core
21 Yoke
21a End
22 Split core (cold storage body, core member)
221 Outer circumferential surface
2211 Step
2211a Axial orthogonal face
2211b Axial direction face
223 End face on axial direction inside
224 Side
224a First side
224b Second side
224c Third side
224d Fourth side
3 Superconducting coil (object to be cooled)
31 Outer circumferential surface
4 Vacuum insulation container
41 Upper wall
42 Wall on axial direction inside
43 Wall on axial direction outside
Split core coil assembly
6 Working space
7 Support member
8 Spacer member
O Axis
AD Axial direction (opposing direction)
ADI Axial direction inside
ADO Axial direction outside
OD Axial orthogonal direction
VD Longitudinal direction
VD1 Longitudinal direction first side
VD2 Longitudinal direction second side
DD Depth direction

1. A cooling system comprising:
a vacuum insulation container;
an object to be cooled, arranged in the vacuum insulation container;
a cryogenic refrigerator comprising a cold stage configured to generate cold;
a thermal conduction connector connecting the cold stage and the object to be cooled in a thermally conductive manner;
one or more temperature sensors;
a current lead arranged in the vacuum insulation container; and
a controller, wherein
the one or more temperature sensors are each configured to detect a temperature of one of the object to be cooled, the cold stage, the thermal conduction connector, and the current lead, and
the controller is configured to perform
an operation stop process to stop operation of the cryogenic refrigerator in a case in which, while the cryogenic refrigerator is operating, the temperature detected by any one of the one or more temperature sensors drops to a predetermined target cooling temperature, and
an operation start process to start operation of the cryogenic refrigerator in a case in which, while operation of the cryogenic refrigerator is stopped, the temperature detected by any one of the one or more temperature sensors rises to a predetermined operation start temperature that is higher than the predetermined target cooling temperature.

2. The cooling system according to claim 1, wherein the predetermined target cooling temperature is equal to or greater than a temperature of the cold stage when a cooling load of the cold stage is 5 W.

3. The cooling system according to claim 1, wherein
the object to be cooled is configured to include a high-temperature superconducting wire, and
the predetermined operation start temperature is equal to or less than a maximum temperature at which the high-temperature superconducting wire can be made superconducting.

4. The cooling system according to claim 1, wherein the thermal conduction connector comprises a cold storage body.

5. The cooling system according to claim 4, wherein the cold storage body has a greater heat capacity than the object to be cooled.

6. The cooling system according to claim 4, wherein
the thermal conduction connector comprises one or more heat equalizing members, and
the one or more heat equalizing members are in contact with the cold storage body over an entire outer circumferential surface of the cold storage body.

7. The cooling system according to claim 6, wherein
the thermal conduction connector comprises one or more cooling conduction members, and
the one or more cooling conduction members are in contact with the one or more heat equalizing members and the object to be cooled.

8. The cooling system according to claim 4, wherein
the cold storage body is a core member,
the object to be cooled is a superconducting coil, and
the superconducting coil is wound around the core member.

9. The cooling system according to claim 4, wherein
the cooling system is configured for use in a magnetic field generator,
the magnetic field generator comprises
the cooling system, and
a yoke that is substantially C-shaped or substantially U-shaped,
the cooling system comprises one or a pair of the vacuum insulation containers,
the cooling system comprises a pair of superconducting coils, each superconducting coil being the object to be cooled,
the cooling system comprises a pair of split cores, each split core being the cold storage body,
the pair of split cores are configured separately from the yoke, are located inside the yoke, and are arranged facing each other with a working space therebetween,
in each split core, each superconducting coil is wound along a circumferential direction centering on an axis parallel to a direction in which the pair of split cores face each other,
a split core coil assembly comprising the split core and the superconducting coil wound around the split core is housed in the one or pair of the vacuum insulation containers, and
the yoke is arranged outside of the one or pair of vacuum insulation containers.

10. A magnetic field generator comprising:
the cooling system according to claim 4; and
a yoke that is substantially C-shaped or substantially U-shaped, wherein
the cooling system comprises one or a pair of the vacuum insulation containers,
the cooling system comprises a pair of superconducting coils, each superconducting coil being the object to be cooled,
the cooling system comprises a pair of split cores, each split core being the cold storage body,
the pair of split cores are configured separately from the yoke, are located inside the yoke, and are arranged facing each other with a working space therebetween,
in each split core, each superconducting coil is wound along a circumferential direction centering on an axis parallel to a direction in which the pair of split cores face each other,
a split core coil assembly comprising the split core and the superconducting coil wound around the split core is housed in the one or pair of the vacuum insulation containers, and
the yoke is arranged outside of the one or pair of vacuum insulation containers.

11. A method of operation for the cooling system according to claim 1, the method comprising:
stopping, by the controller, operation of the cryogenic refrigerator in a case in which, while the cryogenic refrigerator is operating, the temperature detected by any one of the one or more temperature sensors drops to a predetermined target cooling temperature; and
starting, by the controller, operation of the cryogenic refrigerator in a case in which, while operation of the cryogenic refrigerator is stopped, the temperature detected by any one of the one or more temperature sensors rises to a predetermined operation start temperature that is higher than the predetermined target cooling temperature.
